(19) United States
(12) Patent Application Publication
(10) Pub. No.: US 2025/0121293 A1
(43) Pub. Date: Apr. 17, 2025

(54) GAMING SYSTEMS AND METHODS

(71) Applicant: Sportslytx LLC, Alpharetta, GA (US)

(72) Inventors: Steven Charles Fall, Alpharetta, GA (US); Sabir Muhammad, Atlanta, GA (US); Amit Sharma Thongatabam, Costa Mesa, CA (US)

(73) Assignee: Sportslytx LLC, Alpharetta, GA (US)

(21) Appl. No.: 18/913,752

(22) Filed: Oct. 11, 2024

Related U.S. Application Data
(60) Provisional application No. 63/543,873, filed on Oct. 12, 2023.

(51) Int. Cl. A63F 13/828; A63F 13/537

(52) U.S. Cl. CPC A63F 13/828; A63F 13/537

(57) ABSTRACT

Computer-implemented gaming systems, according to various embodiments, are configured to facilitate playing a fantasy sports game in which a plurality of players compete over a fixed duration of time based on the players' respective selections of a respective plurality of discrete events occurring at least substantially in real time, during the fixed duration of the game. For example, in the context of fantasy baseball, the system may facilitate allowing users to play a fantasy baseball game in less than about 4, less than about 3, or less than about 2 hours by allowing the users to select live, player plate appearances that occur during the fixed duration of the game, and then calculating the players' respective scores based on the outcome of those at-bats.

### CROSS-REFERENCE TO RELATED APPLICATIONS

This application claims priority to U.S. Provisional Patent Application Ser. No. 63/543,873, filed Oct. 12, 2023, the disclosure of which is hereby incorporated by reference in its entirety.

### BACKGROUND

Current computer systems for facilitating playing fantasy sports games suffer various technical challenges. Included among such challenges are the fact that such computer systems typically require individual games to be played over the course of a relatively long period of time, such as a day, a weekend, or a longer period, such as Thursday through Sunday. In addition, such computer systems may score points based on a particular player's performance over the course of an entire game and/or may require making long-term commitments to particular players.

Players (“users”) of fantasy sports games may wish to start and finish a fantasy sports game within a relatively short period of time (e.g., within 30 minutes, an hour, or two hours). Players may also wish to play fantasy games that don't require the research or commitment that is typically needed in advance of a typical fantasy draft.

Accordingly, there is currently a technical need for improved computer systems for allowing users to play fantasy sports games in relatively short periods of time and/or without significant preparation time or commitment.

### SUMMARY

Computer-implemented gaming systems, according to various embodiments, are configured to facilitate playing a fantasy sports game in which a plurality of players compete over a fixed duration of time based on the players' respective selections of a respective plurality of discrete events occurring at least substantially in real time, during the fixed duration of the game. For example, in the context of various embodiments of a fantasy baseball game (such various embodiments of the fantasy games described below), the system may facilitate allowing users to play a complete fantasy baseball game in less than about 4, less than about 3, less than about 2 hours, or less than about 1 hour by allowing the users to select live, player plate appearances that occur during the fixed duration of the game, and then calculating the players' respective scores for the game based least in part on the outcome of those respective plate appearances.

A computer-implemented method, according to various embodiments, comprises: (1) receiving, by one or more computer processors, information regarding a plurality of sporting events, the information comprising information regarding the individual performance of a plurality of players that are each participating in at least one of the plurality of sporting events; and (2) establishing, the by one or more computer processors, a virtual game in which at least a first individual and a second individual compete based at least in part on: (A) a first subset of respective discrete performance events that are each executed by a respective one of the players as the respective player participates in at least one of the sporting events, the first subset of respective discrete performance events having been selected by the first individual; and (B) a second subset of respective discrete performance events that are each executed by a respective one of the players as the respective player participates in at least one of the sporting events, the second subset of respective discrete performance events having been selected by the second individual; (3) determining, by the one or more computer processors, a score of the virtual game based, at least in part on the first and second subsets of discrete performance events; and (4) conveying, by the one or more computer processors, the score to the first and second individuals (e.g., by displaying the score on a display screen).

### BRIEF DESCRIPTION OF THE DRAWINGS

In the course of this description, reference will be made to the accompanying drawings, which are not necessarily drawn to scale, and wherein:

FIG. 1 is a screenshot of a computer-implemented fantasy baseball game according to a particular embodiment;

FIG. 2 is a further screenshot of a computer-implemented fantasy baseball game according to a particular embodiment;

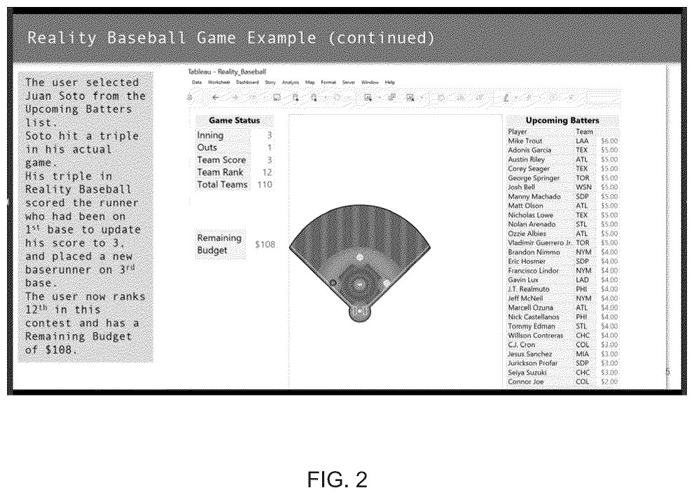

FIG. 3 depicts an example gaming module according to various embodiments;

FIG. 4 depicts an example of a computing environment in accordance with various embodiments of the present disclosure; and

FIG. 5 depicts an example of a system architecture that may be used in accordance with various aspects of the present disclosure.

### DETAILED DESCRIPTION

Various embodiments now will be described more fully hereinafter with reference to the accompanying drawings. It should be understood that various embodiments may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A gaming system according to various embodiments is adapted to facilitate playing one or more fantasy sports games. In particular embodiments, the gaming system includes one or more servers and is connected to a large number (e.g., hundreds or thousands) of remote computers via a wide area LAN such as the Internet or other suitable computer network. This may, for example, allow a large number of users (e.g., hundreds or thousands of users) to simultaneously participate in one or more of a large number of fantasy sports games that are being simultaneously hosted by the gaming system.

In various embodiments, the gaming system may receive information regarding multiple particular sporting events (e.g., at least two, three, four, five, etc. sporting events) that are being played at the same time (e.g., multiple games of a particular sport, such as baseball, basketball, soccer or football, that are being played at the same time). The system then hosts individual fantasy sports games between two or more users who access the gaming system via their respective remote computing devices (e.g., via the Internet).

In particular embodiments, to initiate a particular game, a first user pays a certain amount of money to play the game. In return, the gaming system assigns the first user a certain amount of fantasy currency that the first user may use to “purchase” discrete performance events executed by individual players who are participating in at least one of the sporting events (e.g., a particular plate appearance for a particular baseball player who is participating in a particular baseball game). The gaming system then uses a gaming algorithm to assign the first user points that correspond to the discrete performance events purchased by the first user. The system also completes this process for other users playing in the same instance of the fantasy game.

As the game goes along, the system displays the users' respective points. The game ends upon the occurrence of one or more game completion events (e.g., a predetermined amount of time has lapsed (e.g., less than 3 hours, less than 2 hours, less than 1 hour, or less than 30 minutes), a predetermined number of innings have been played (e.g., 9, 8, 7, 6, 5, etc. innings), a predetermined number of points have been scored, etc.). When the game ends, the gaming system determines one or more winners of the game according to the gaming algorithm. For example, the system may determine which particular user has the most (or least) points at the end of the game and designate that particular user to be the winner of the game. The gaming system may then optionally convey one or more benefits to the winner of the game (e.g., the system may transfer money to the user that may, for example, at least partially correspond to the amount of money that the winning user and/or one or more other users that participated in the game paid to play the game.)

In a particular example, the system is configured to facilitate playing fantasy baseball games. In this example, the system receives data from at least three baseball games (e.g., professional baseball games) that are being played at least partially at the same time. It should be understood that the baseball games need not start and/or end at exactly the same time. In particular embodiments, the games just need to at least partially overlap.

The system may begin initiating a particular fantasy baseball game by assigning two or more users to a particular instance of the fantasy baseball game. The system may do this randomly (e.g., from a queue of online users who have indicated that they would like to play the game online) or based on one or more particular factors, such as the users' respective skill levels, the amount of money that the users have indicated that they will pay for playing the instance of the game, the users' respective locations, etc.

After a particular number of users have been assigned to the particular instance of the baseball game (e.g., two users have been assigned to a particular instance of the game), as noted above, the system assigns an appropriate amount of currency to be used to buy particular individual “plate appearances” of the players that are currently playing in the various games. The users may, for example, do this in real time as the various players come up to bat.

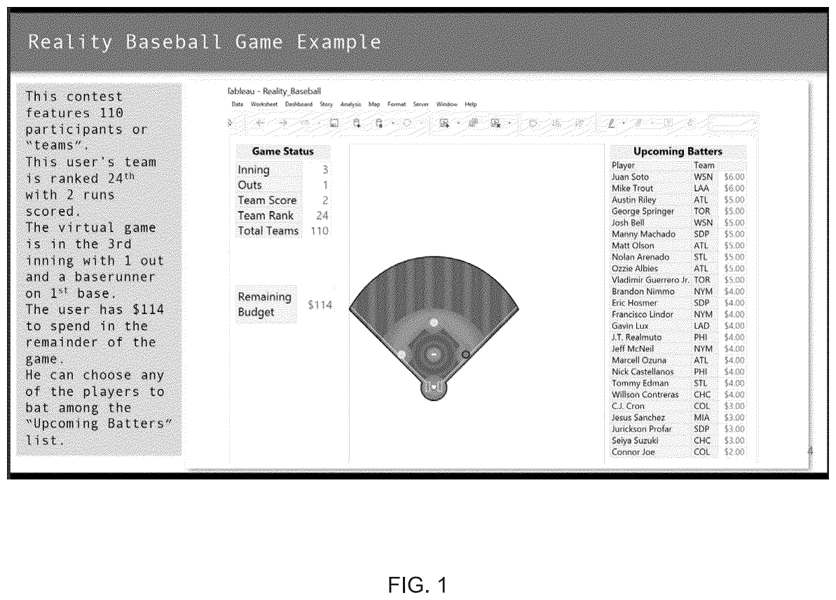

FIG. 1 shows a screen shot of gameplay of the baseball game noted above at a particular period of time. As may be understood from this figure, in this embodiment, the gaming system displays a virtual depiction of a baseball field and visually indicates which bases have runners on them. The system also displays fantasy game status information, such as: (1) the current inning; (2) the current number of outs in the inning; (3) the team's current score; (4) the team's current rank within the particular instance of the game; and (5) the total number of teams that are currently playing the particular instance of the fantasy game. The gaming system may also display the player's remaining budget. In addition, the gaming system may display a list of real-world batters that will be up to bat in the near future (upcoming batters) along with a price list indicating how much it would cost to purchase each player's respective next plate appearance.

When playing the game, each user indicates which player's next plate appearance the player wishes to purchase. For example, in the example below, the user may select the $6.00 indicator next to Juan Soto to purchase Juan Soto's next plate appearance. When Juan Soto completes his next plate appearance, the system will then adjust the user's Game Status accordingly. For example, if Juan Soto strikes out at his next plate appearance, the system will make adjustments to the display in accordance with standard baseball rules. In the example shown in FIG. 1, the system will advance the number of Outs to “2” and not change the display of players on base. The system will also adjust the user's Remaining Budget to reflect the purchase of Juan Soto's plate appearance. That is, it will subtract $6 from the $114 budget and update the display to reflect a remaining budget of $108.

Continuing with this example, if the user then selects Mike Trout's next plate appearance for $6 and Mike Trout hits a triple at his next plate appearance, the gaming system will do several things. First, it will update the field display to show one runner (Mike Trout) on third base (e.g., by changing the color of third base on the display to a color that is different from the color of other bases that don't have a virtual runner on them). The system will also update the field display to remove the runner that is currently on first base (e.g., by returning the display of first base to its “unoccupied” color). The system will also: (1) update the Team Score to 3, since the runner who was previously on first base scored; (2) reduce the user's displayed remaining budget to $102 (the player's previous budget of $108 minus the cost of Mike Trout's plate appearance, which in this case was $6), and (3) compare the team's current score with the scores of all of the other teams that are playing in the current instance of the baseball game and then update the displayed Team Rank to reflect the instant team's current ranking among those teams (where the teams are ranked, for example, based on the points (runs) that they have scored).

The game follows in this manner until the player receives three outs. At that point, the system advances the number of innings by one and the process above repeats in the same way for the next inning. In this example, this process occurs until each user completes a pre-determined number of innings (e.g., nine innings).

When all players for the particular instance of the game have completed the pre-determined number of innings, the gaming system determines a final ranking of players (e.g., based on their respective total runs scored) and issues one or more awards accordingly. For example, the system may issue a first amount of prize money to the user who ends the game in first place, a second amount of prize money to the user who ends the game in second place, and a third amount of prize money to the user who ends the game in third place. It should be understood that, in various embodiments, any suitable number of players may play in a particular game (e.g., 2, 3, 4, 5, or more players may play in a particular game).

It should be understood that different gaming algorithms may be used in conducting play. For example, particular algorithms may end a user's game earlier than the pre-determined number of innings if, for example, the player runs out of money before completing the pre-determined number of innings.

It should be understood in light of this disclosure that, while the present example is described in regard to a fantasy baseball game, other embodiments may include gaming systems for facilitating other types of fantasy games, such as fantasy football games, fantasy basketball games, fantasy soccer games, fantasy golf games, etc. In various embodiments of such fantasy games, the fantasy game may generally follow the rules of the underlying sport, but award points based on the collective live, real-time performances of multiple real-world players that are playing while the fantasy game is being played in real-time.

### Gaming Module

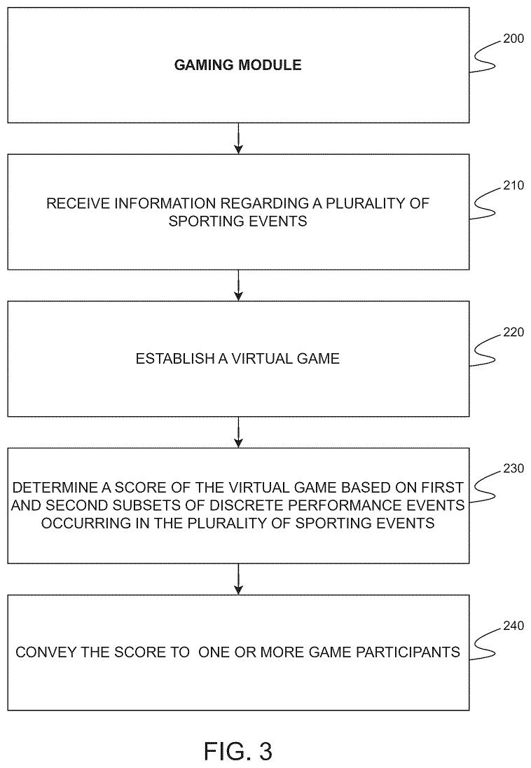

FIG. 3 shows a gaming module 200 according to various embodiments. This gaming module 200 is an example gaming module (e.g., in the form of computer-executable instructions stored on a suitable computer-readable medium) that may be executed by a gaming server 100. As may be understood from FIG. 3, when the gaming server 100 executes the gaming module, the system begins at Step 210 where it receives information regarding a plurality of sporting events. In the context of baseball, this information may include, for example, at least substantially real-times (e.g., live) information regarding multiple baseball games that are in progress. Such information may include, for example: (1) one or more batting lineups; (2) the identity of a current batter and/or one or more on-deck batters; (3) current pitch count information; (4) information regarding one or more players' respective performances within the various games (e.g., information indicating that a current batter got a base hit and information regarding how many bases the batter advanced on the hit); (5) information regarding how many bases on-base runners advanced as the result of a current hit; (6) current game score and/or (7) any other suitable information regarding the particular games.

Next, the step advances to Step 220, where it establishes a virtual game based on: (1) a first subset of respective discrete performance events that are each executed by a respective one of the players as the respective player participates in at least one of the sporting events, the first subset of respective discrete performance events having been selected by a first individual (a first player of a particular fantasy baseball game); and (2) a second subset of respective discrete performance events that are each executed by a respective one of the players as the respective player participates in at least one of the sporting events, the second subset of respective discrete performance events having been selected by a second individual (a second player of the particular fantasy baseball game). Such discrete performance events may include, for example, one or more single plate appearances of particular real-world baseball players.

The system then advances to Step 230 where it determines, by the one or more computer processors, a score of the virtual game based, at least in part on the first and second subsets of discrete performance events.

The system then advances to Step 240 where it conveys the score to one or more game participants.

### Example Technical Platforms

Aspects of the present disclosure may be implemented in various ways, including as computer program products that include articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described herein with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

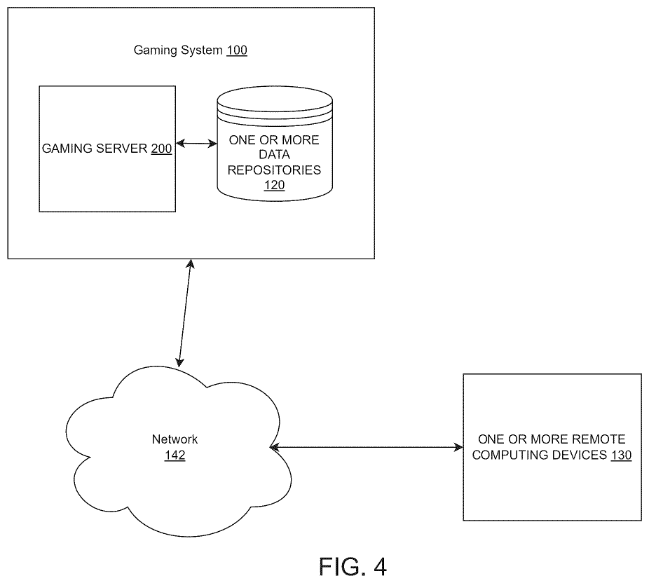

FIG. 4 is an example of a computing environment that can be used in various embodiments. As may be understood from FIG. 4, the system architecture according to various aspects may include a gaming system 100 that includes a gaming server 200 and one or more data repositories 120. Although the gaming server 100 and one or more data repositories 120 are shown as separate components, according to other aspects, these components may include a single server and/or repository, servers and/or repositories, one or more cloud-based servers and/or repositories, or any other suitable configuration. In addition, the system architecture according to various aspects may include one or more remote computing devices (e.g., remote computing systems) 130.

In particular embodiments, the gaming system 100 and one or more remote computing devices 130 may communicate with, access, and/or the like with each other over one or more networks 142, which may include, for example, one or more Wide Area Networks (e.g., the Internet) and/or one or more Local Area Networks. Furthermore, the gaming system 100 and the one or more remote computing devices 130 may provide one or more interfaces that allow the gaming system 100, the remote computing devices 130, etc. to communicate with each other such as one or more suitable application programming interfaces (APIs), direct connections, and/or the like.

### Example Computing Hardware

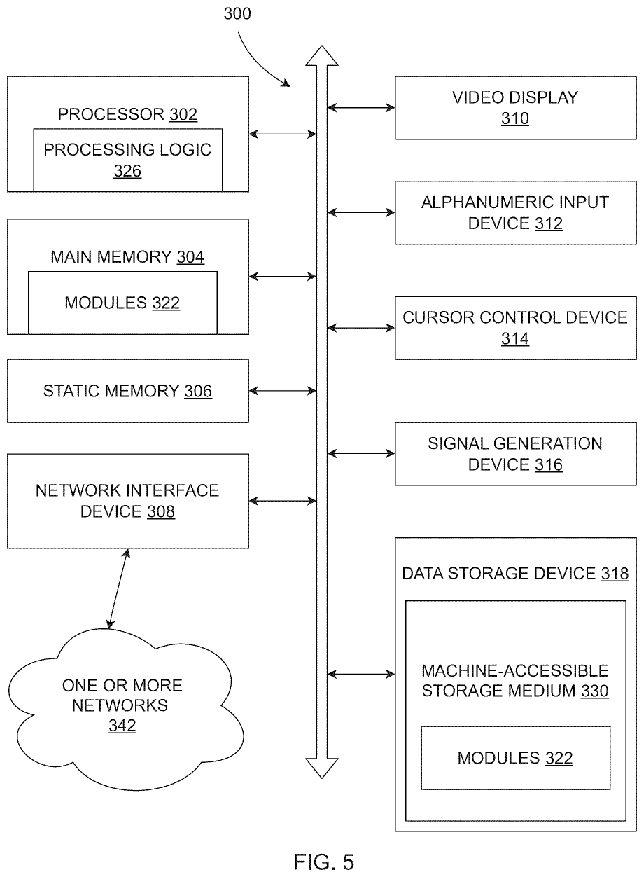

FIG. 5 illustrates a diagrammatic representation of a computing hardware device 300 that may be used in accordance with various aspects of the disclosure. For example, the hardware device 300 may be computing hardware such as the gaming server 200 or one or more remote computing devices 130 shown in FIG. 1. According to particular aspects, the hardware device 300 may be connected (e.g., networked) to one or more other computing entities, storage devices, and/or the like via one or more networks such as, for example, a LAN, an intranet, an extranet, and/or the Internet. As noted above, the hardware device 300 may operate in the capacity of a server and/or a client device in a client-server network environment, or as a peer computing device in a peer-to-peer (or distributed) network environment. According to various aspects, the hardware device 300 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 300 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 300 includes a processor 302, a main memory 304 (e.g., read-only memory (ROM), flash memory, dynamic random-access memory (DRAM) such as synchronous DRAM (SDRAM), Rambus DRAM (RDRAM), and/or the like), a static memory 306 (e.g., flash memory, static random-access memory (SRAM), and/or the like), and a data storage device 318, that communicate with each other via a bus 332.

The processor 302 may represent one or more general-purpose processing devices such as a microprocessor, a central processing unit, and/or the like. According to some aspects, the processor 302 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 302 may be one or more special-purpose processing devices such as an application specific integrated circuit (ASIC), a field programmable gate array (FPGA), a digital signal processor (DSP), network processor, and/or the like. The processor 302 can execute processing logic 326 for performing various operations and/or steps described herein.

The hardware device 300 may further include a network interface device 308, as well as a video display unit 310 (e.g., a liquid crystal display (LCD), a cathode ray tube (CRT), and/or the like), an alphanumeric input device 312 (e.g., a keyboard), a cursor control device 314 (e.g., a mouse, a trackpad), and/or a signal generation device 316 (e.g., a speaker). The hardware device 300 may further include a data storage device 318. The data storage device 318 may include a non-transitory computer-readable storage medium 330 (also known as a non-transitory computer-readable storage medium or a non-transitory computer-readable medium) on which is stored one or more modules 322 (e.g., sets of software instructions) embodying any one or more of the methodologies or functions described herein. For instance, according to particular aspects, the modules 322 include the gaming module 200. as described herein. The one or more modules 322 may also reside, completely or at least partially, within main memory 304 and/or within the processor 302 during execution thereof by the hardware device 300—main memory 304 and processor 302 also constituting computer-accessible storage media. The one or more modules 322 may further be transmitted or received over a suitable network 142 via the network interface device 308.

While the computer-readable storage medium 330 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 300 and that causes the hardware device 300 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented method comprising:
receiving, by one or more computer processors, information regarding a plurality of sporting events, the information comprising information regarding the individual performance of a plurality of players that are each participating in at least one of the plurality of sporting events; and
establishing, the by one or more computer processors, a virtual game in which at least a first individual and a second individual compete based at least in part on:
(1) a first subset of respective discrete performance events that are each executed by a respective one of the players as the respective player participates in at least one of the sporting events, the first subset of respective discrete performance events having been selected by the first individual; and
(2) a second subset of respective discrete performance events that are each executed by a respective one of the players as the respective player participates in at least one of the sporting events, the second subset of respective discrete performance events having been selected by the second individual;
determining, by the one or more computer processors, a score of the virtual game based, at least in part on the first and second subsets of discrete performance events; and
conveying, by the one or more computer processors, the score to the first and second individuals.

2. The computer-implemented method of claim 1, wherein:
the information regarding the individual performance of the plurality of players comprises a set of respective discrete performance events that have each been executed by a respective one of the players as the respective player participates in at least one of the sporting events;
the first subset of respective discrete performance events comprise a first subset of the set of respective discrete performance events;
the second subset of respective discrete performance events comprise a second subset of the set of respective discrete performance events;
determining the score of the first game comprises:
accessing a set of scoring rules;
applying the set of scoring rules to each respective discrete performance event in the set of respective discrete performance events to determine a set of respective discrete performance event scores; and
determining the score of the virtual game based at least in part on the first and second subsets of discrete performance events and the set of respective discrete performance event scores; and
conveying the score to the first and second individuals comprises:
generating a first user interface by configuring a display element that:
includes the score and a first subset of the set of respective discrete performance event scores that are associated with the first subset of respective discrete performance events; and
excludes a second subset of the set of respective discrete performance event scores that are not associated with the first subset of respective discrete performance events; and
generating a second user interface by configuring a second display element that:
includes the score and a third subset of the set of respective discrete performance event scores that are associated with the second subset of respective discrete performance events; and
excludes a fourth subset of the set of respective discrete performance event scores that are not associated with the second subset of respective discrete performance events;
providing the first user interface for display on a computing device associated with the first user; and
providing the second user interface for display on a second computing device associated with the first user.

3. The computer-implemented method of claim 1, further comprising:
generating a first customized interface that is specific to the first individual by applying a set of scoring rules to the first subset of respective discrete performance events to determine a set of first respective discrete performance event scores and configuring the first customized interface to include the score and at least one first discrete performance event score from the set of first respective discrete performance event scores associated with at least one of the first subset of respective discrete performance events;
generating a second customized interface that is specific to the second individual by applying the set of scoring rules to the second subset of respective discrete performance events to determine a set of second respective discrete performance event scores and configuring the second customized interface to include the score and at least one second discrete performance event score from the set of second respective discrete performance event scores associated with at least one of the second subset of respective discrete performance events;
providing the first customized interface for display on a first computing device associated with the first individual; and
providing the second customized interface for display on a second computing device associated with the second individual.

4. The computer-implemented method of claim 3, further comprising:
modifying, in response to an occurrence of a first respective discrete performance event in the first subset of respective discrete performance events, the first customized user interface based on the occurrence.

5. The computer-implemented method of claim 4, wherein modifying the first customized user interface occurs substantially in real time with the occurrence of the first respective discrete performance event.

6. The computer-implemented method of claim 4, wherein at least a portion of the plurality of sporting events occur at substantially the same time.

7. The computer-implemented method of claim 1, wherein:
each of the plurality of players is a baseball player; and
at least one of the discrete performance events is a batting turn in a baseball game.

8. The computer-implemented method of claim 7, wherein one or more computer processors determine the score based, at least in part, on the number of runs batted in for each of the respective batting turns.

9. The computer-implemented method of claim 8, wherein the computer-implemented method comprises determining, by one or more computer processors, a winner of the virtual game based, at least in part, on the respective number of runs batted in during the first and second subsets of discrete performance events.

10. A computer-readable medium storing computer-executable instructions for:
receiving, by one or more computer processors, information regarding a plurality of sporting events, the information comprising information regarding the individual performance of a plurality of players that are each participating in at least one of the plurality of sporting events; and
establishing, the by one or more computer processors, a virtual game in which at least a first individual and a second individual compete based at least in part on:
(1) a first subset of respective discrete performance events that are each executed by a respective one of the players as the respective player participates in at least one of the sporting events, the first subset of respective discrete performance events having been selected by the first individual; and
(2) a second subset of respective discrete performance events that are each executed by a respective one of the players as the respective player participates in at least one of the sporting events, the second subset of respective discrete performance events having been selected by the second individual;
determining, by the one or more computer processors, a score of the virtual game based, at least in part on the first and second subsets of discrete performance events; and
conveying, by the one or more computer processors, the score to the first and second individuals.

11. The computer-readable medium of claim 10, wherein:
the information regarding the individual performance of the plurality of players comprises a set of respective discrete performance events that have each been executed by a respective one of the players as the respective player participates in at least one of the sporting events;
the first subset of respective discrete performance events comprise a first subset of the set of respective discrete performance events;
the second subset of respective discrete performance events comprise a second subset of the set of respective discrete performance events;
determining the score of the first game comprises:
accessing a set of scoring rules;
applying the set of scoring rules to each respective discrete performance event in the set of respective discrete performance events to determine a set of respective discrete performance event scores; and
determining the score of the virtual game based at least in part on the first and second subsets of discrete performance events and the set of respective discrete performance event scores; and
conveying the score to the first and second individuals comprises:
generating a first user interface by configuring a display element that:
includes the score and a first subset of the set of respective discrete performance event scores that are associated with the first subset of respective discrete performance events; and
excludes a second subset of the set of respective discrete performance event scores that are not associated with the first subset of respective discrete performance events; and
generating a second user interface by configuring a second display element that:
includes the score and a third subset of the set of respective discrete performance event scores that are associated with the second subset of respective discrete performance events; and
excludes a fourth subset of the set of respective discrete performance event scores that are not associated with the second subset of respective discrete performance events;
providing the first user interface for display on a computing device associated with the first user; and
providing the second user interface for display on a second computing device associated with the first user.

12. The computer-readable medium of claim 11, wherein the computer-readable medium further stores computer-executable instructions for:
generating a first customized interface that is specific to the first individual by applying a set of scoring rules to the first subset of respective discrete performance events to determine a set of first respective discrete performance event scores and configuring the first customized interface to include the score and at least one first discrete performance event score from the set of first respective discrete performance event scores associated with at least one of the first subset of respective discrete performance events;
generating a second customized interface that is specific to the second individual by applying the set of scoring rules to the second subset of respective discrete performance events to determine a set of second respective discrete performance event scores and configuring the second customized interface to include the score and at least one second discrete performance event score from the set of second respective discrete performance event scores associated with at least one of the second subset of respective discrete performance events;
providing the first customized interface for display on a first computing device associated with the first individual; and
providing the second customized interface for display on a second computing device associated with the second individual.

13. The computer-readable medium of claim 12, wherein the computer-readable medium further stores computer-executable instructions for:
modifying, in response to an occurrence of a first respective discrete performance event in the first subset of respective discrete performance events, the first customized user interface based on the occurrence.

14. The computer-readable medium of claim 13, wherein modifying the first customized user interface occurs substantially in real time with the occurrence of the first respective discrete performance event.

15. The computer-readable medium of claim 13, wherein at least a portion of the plurality of sporting events occur at substantially the same time.

16. A computer-implemented gaming system comprising:
one or more computer processors; and
memory that is operatively coupled to the at least one computer processor, wherein the computer-implemented gaming system is configured for:
receiving, by the one or more computer processors, information regarding a plurality of sporting events, the information comprising information regarding the individual performance of a plurality of players that are each participating in at least one of the plurality of sporting events; and
establishing, by the one or more computer processors, a virtual game in which at least a first individual and a second individual compete based at least in part on:
(1) a first subset of respective discrete performance events that are each executed by a respective one of the players as the respective player participates in at least one of the sporting events, the first subset of respective discrete performance events having been selected by the first individual; and
(2) a second subset of respective discrete performance events that are each executed by a respective one of the players as the respective player participates in at least one of the sporting events, the second subset of respective discrete performance events having been selected by the second individual;
determining, by the one or more computer processors, a score of the virtual game based, at least in part on the first and second subsets of discrete performance events; and
conveying, by the one or more computer processors, the score to the first and second individuals.

17. The computer-implemented gaming system of claim 16, wherein:
the information regarding the individual performance of the plurality of players comprises a set of respective discrete performance events that have each been executed by a respective one of the players as the respective player participates in at least one of the sporting events;
the first subset of respective discrete performance events comprise a first subset of the set of respective discrete performance events;
the second subset of respective discrete performance events comprise a second subset of the set of respective discrete performance events;
determining the score of the first game comprises:
accessing a set of scoring rules;
applying the set of scoring rules to each respective discrete performance event in the set of respective discrete performance events to determine a set of respective discrete performance event scores; and
determining the score of the virtual game based at least in part on the first and second subsets of discrete performance events and the set of respective discrete performance event scores; and
conveying the score to the first and second individuals comprises:
generating a first user interface by configuring a display element that:
includes the score and a first subset of the set of respective discrete performance event scores that are associated with the first subset of respective discrete performance events; and
excludes a second subset of the set of respective discrete performance event scores that are not associated with the first subset of respective discrete performance events; and
generating a second user interface by configuring a second display element that:
includes the score and a third subset of the set of respective discrete performance event scores that are associated with the second subset of respective discrete performance events; and
excludes a fourth subset of the set of respective discrete performance event scores that are not associated with the second subset of respective discrete performance events;
providing the first user interface for display on a computing device associated with the first user; and
providing the second user interface for display on a second computing device associated with the first user.

18. The computer-implemented gaming system of claim 17, wherein the computer-implemented gaming system is further configured for:
generating a first customized interface that is specific to the first individual by applying a set of scoring rules to the first subset of respective discrete performance events to determine a set of first respective discrete performance event scores and configuring the first customized interface to include the score and at least one first discrete performance event score from the set of first respective discrete performance event scores associated with at least one of the first subset of respective discrete performance events;
generating a second customized interface that is specific to the second individual by applying the set of scoring rules to the second subset of respective discrete performance events to determine a set of second respective discrete performance event scores and configuring the second customized interface to include the score and at least one second discrete performance event score from the set of second respective discrete performance event scores associated with at least one of the second subset of respective discrete performance events;
providing the first customized interface for display on a first computing device associated with the first individual; and
providing the second customized interface for display on a second computing device associated with the second individual.

19. The computer-implemented gaming system of claim 18, wherein the computer-implemented gaming system is further configured for:
modifying, in response to an occurrence of a first respective discrete performance event in the first subset of respective discrete performance events, the first customized user interface based on the occurrence.

20. The computer-implemented gaming system of claim 19, wherein modifying the first customized user interface occurs substantially in real time with the occurrence of the first respective discrete performance event.
